(19) United States
(12) Patent Application Publication
(10) Pub. No.: US 2019/0236729 A1
(43) Pub. Date: Aug. 1, 2019

(54) REAL ESTATE METHOD FOR LINKING BUYERS AND SELLERS WITH INTERFACE

(71) Applicant: Andy Vong, San Jose, CA (US)

(72) Inventor: Andy Vong, San Jose, CA (US)

(21) Appl. No.: 16/258,471

(22) Filed: Jan. 25, 2019

Related U.S. Application Data
(60) Provisional application No. 62/622,418, filed on Jan. 26, 2018.

(51) Int. Cl. G06Q 50/16; G06Q 30/06

(52) U.S. Cl. CPC G06Q 50/16; G06Q 30/0625; G06Q 30/0641

(57) ABSTRACT

A method for conducting a real estate transaction between users; the method is advantageous for conducting a real estate transaction without the involvement of agents or brokers, thereby eliminating complication of interests and expensive broker fees. The method includes providing an electronic database which is able to store real estate listings; providing a graphical user interface via a computing device; receiving a search query from the buyer for real estate listings; receiving buyer information; selecting matches from among the real estate listings; providing the buyer with at least one match; pairing the buyer to at least one seller; permitting the buyer and seller to communicate; providing a transaction contract; verifying and recording the transaction contract; pairing the buyer to an escrow service; and charging the buyer a subscription fee.

### CROSS-REFERENCE TO RELATED APPLICATION(S)

The present application is related to and claims priority to U.S. Provisional Patent Application No. 62/622,418 filed Jan. 26, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The method relates generally to the field of brokerage processes of existing art and more specifically relates to a computer-implemented brokerage system.

### RELATED ART

When consumers sell or buy their real estate, normally the property owner (seller) will hire the real estate broker and the seller will be responsible to pay a percentage of the selling price for the service of the real estate broker as commission. The seller may or may not receive the best timing on service from the real estate brokers or agents the sellers hired during the selling process. In certain circumstances from time to time buyers may have to pay commission to their real estate brokers or agents. In some cases, buyers also may or may not be able to find a property that really matches the buyer criteria because their broker or agent is showing the buyers limited options. Buyers may also not have access to the newest listings that go on the market when using a broker. A suitable solution is desired.

U.S. Pat. No. 6,684,196 to Juan F. Mini et al. relates to a beginning-to-end online automation of real estate transactions. The described beginning-to-end online automation of real estate transactions includes methods and an apparatus for facilitating a transaction corresponding to real property between a seller and a buyer via a network. A negotiation relating to the real property between the buyer and the seller is facilitated via the network. Access by at least one of the buyer and the seller via the network to a plurality of real estate services is provided. Each of the plurality of real estate services relates to an aspect of the transaction, and each of the plurality of real estate services is necessary for the transaction to progress.

### SUMMARY OF THE INVENTION

In view of the foregoing disadvantages inherent in the known matching process art, the present disclosure provides a novel real estate method for linking buyers and sellers with interface means. The general purpose of the present disclosure, which will be described subsequently in greater detail, is to provide a real estate method (means) for linking buyers and sellers which effectively eliminates personal brokers and improves buyer autonomy.

A method for conducting a real estate transaction between users is disclosed herein. The method is advantageous for conducting a real estate transaction without the involvement of agents or brokers, thereby eliminating complication of interests and expensive broker fees. The method includes providing an electronic database which is able to store real estate listings; providing a graphical user interface via a computing device which enables a buyer to browse the real estate listings; receiving a search query from the buyer for real estate listings; receiving buyer information which relates to the buyer's real estate preferences; selecting matches from among the real estate listings that match the buyer information (specified); providing the buyer with at least one match in response to the buyer's query; pairing the buyer to at least one seller corresponding to each of the matches; permitting the buyer to communicate and transact directly with the at least one seller; providing a transaction contract to the buyer and the seller; verifying and recording the transaction contract; pairing the buyer to at least one escrow service; and charging the buyer a subscription fee.

According to another embodiment, a user-interface for implementing the method for conducting a real estate transaction between users is also disclosed herein. The user-interface includes a homepage for a website. Via the homepage, the user-interface is able to be displayed on a screen of the computing device, such as a desktop computer, laptop, tablet, or smartphone. The homepage includes one or more search bars able to receive a buyer's query for real estate matches, resulting in accessing and searching a database to provide results relating to or comprising of real estate listings; one or more questionnaires for receiving the buyer information relating to real estate search preferences or related buyer information; one or more report pages providing the buyer with real estate listing matches as a response to the buyer's real estate search query; user profile pages corresponding to and customizable by website users; private message interfaces permitting the users to communicate with each other via text-based messages; fillable transaction contracts for conducting real estate transactions; and subscription payment pages for paying service fees which may be required for accessing and using one or more features of the website. A like administrative-interface for implementing the method for conducting a real estate transaction between users is also disclosed herein.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the method will become better understood with reference to the following drawings and detailed description.

### BRIEF DESCRIPTION OF THE DRAWINGS

The figures which accompany the written portion of this specification illustrate embodiments and methods of use for the present disclosure, a real estate method for linking buyers and sellers with an interface, constructed and operative according to the teachings of the present disclosure.

FIG. 1 is a flow chart of the method for linking buyers and sellers during an ‘in-use’ condition, according to an embodiment of the disclosure.

FIG. 2 is a flow chart of the method of FIG. 1, according to an embodiment of the present disclosure.

FIG. 3 is an illustration of a user-interface for implementing the method of FIG. 1, according to an embodiment of the present disclosure.

FIG. 4 is a flow diagram illustrating the method for linking buyers and sellers, according to an embodiment of the present disclosure.

FIG. 5 is a flow diagram illustrating optional steps of the method for linking buyers and sellers of FIG. 4, according to an embodiment of the present disclosure.

The various embodiments of the method will hereinafter be described in conjunction with the appended drawings, wherein like designations denote like elements.

### DETAILED DESCRIPTION

As discussed above, embodiments of the present disclosure relate to a brokerage process and more particularly to a real estate method for linking buyers and sellers with an interface as used to improve the efficient and cost-effective pairing of buyers and sellers to conduct a real estate transaction.

Generally, the method (means) provides a real estate selling service process, which may be implemented via a software program with a website or web base to accommodate the needs of both buyers and sellers. The methodology provides an online marketplace which is able to match sellers and buyers for the purpose of real estate transactions. This may entail multiple distinct services, such as referring buyers to legal services, financing services, escrow services, 1031 exchange services, home inspection services, roof inspection services, termite inspection services and many other services relating or non-relating to real estate industry. Furthermore, the website or web base online real estate matching services may allow buyers and sellers access to a variety of resources, advice, and services for successful transactions while effectively eliminating the need to hire expensive real estate brokers or agent as is necessary in a traditional real estate transaction. The method may include a revenue means accomplished by charging fees to users. In one embodiment, this may include a one-time flat fee which is established independently of the transaction price or the length of time the online marketplace is used. Other embodiments may alternatively include a recurring subscription fee, or the combination of a one-time fee and a recurring subscription fee. The methodology may be useful in saving users time and money by eliminating the need for brokers while also guiding consumers to buy and sell real estate both legally and securely. A primary advantage of the method is to allow a real estate buyer further autonomy from brokers who may represent additional interest contrary to that of the buyer's. Additionally, the method enables further independent education, access, and economic freedom for the buyer-user. The methodology may be implemented via a software program.

Various users may be able to access and use the real estate process of the present invention via a computing device. Generally, access is accomplished by an internet network connection. For the purpose of this disclosure, the term ‘user’ includes at least buyers, sellers, browsers (i.e., an individual who browses), escrow servers, title servers, lenders, and administrators. Users may be required to register with the website by creating a user account in order to access and use features of the method and the user-interface. In some embodiments, registration may include the payment of fees. Once registered, users may be able to post real estate listings for browsing by other users. Users may also be able to browse real estate listings and participate in the other features provided by the method and the user-interface.

A feature of the method may include a guidance program in completing legal documents necessitated by or related to the real estate transaction process, particularly a transaction in which the user is engaged in. The guidance program may include written tutorials, audio tutorials, video tutorials, document labels, or pop-up suggestions that appear as a user is navigating the legal document. The user-interface may include access to a database of legal documents available to registered users for use or download.

A further feature of the method may include service referrals. Services may include at least escrow services, title services, lenders and other financiers, and legal advisors. These services may be associated with or registered with the website implementing the method. Alternatively, the services may be third parties referred to by or advertising with the website.

A primary feature of the method is a real estate search function. The search function may provide a user with a large variety of search parameters which may be applied automatically via a search algorithm to provide real estate listing matches which fall within the user-provided parameters.

The system may include a user interface. The user interface may be defined as a method of managing interactions between a user and a machine (means). In this case, the machine may be a website, a server, a computer, a human-controlled account, or a combination thereof. The user interface may include a front-end interface which is usable by buyer users and seller users. The user interface may also include a back-end interface which is usable by administrative users for maintenance and managerial purposes. Preferably, the user interface is presented to each user via a computer. A computer may be a personal computer, a mobile device, or other machines capable of networking via an internet connection. In some embodiments, the user interface may be hosted on a dedicated server which is accessible via the World Wide Web (www).

The user interface may include selectable options for at least the following functions: a user registration, a user login, a user profile customization feature, a user profile viewing feature, a user dashboard providing customizable options for website navigation, a subscription plan selection page, a subscription payment area, a listing management area, a listing search function, a searchable listing map, a listing search filters utility, a saved listings list, a messaging utility for sending personal messages between human users, a personal messaging windowed utility, an administrative contact utility, a mortgage calculator, and navigation options. These various functions may be selectable and usable in the user interface by the implementation of virtual buttons, menus, and search boxes. Other options may be used as well.

In a preferred embodiment, the user interface may include at least a website homepage. The homepage may also be a website landing page. In this embodiment, the homepage may include a website logo, a navigation menu, a search bar, a list property button, a login/register button, a rotating banner, a site working process button, a subscription plan button, a testimonial button, and a footer with static menu item buttons. Other manipulation/viewing means may be used.

An administrative back-end user interface may be distinct from the front-end user interface. This administrative back-end user interface may include at least an admin dashboard, a user management button, a subscription package management button and function, a listing management button and function, a payment management button and function, a report button and function, an analytics button and function, a content management button and function, and a proposed features button and function.

The user login and account function may have a required or optional feature for logging in a user with a third-party account, for example, an email or social media account. By logging in with a username and password corresponding to the third-party account, the user may gain access and permissions for utilizing the process via the user interface. Other authorization or entry means may be used.

In some embodiments, the searchable and navigable listings map may be provided as a licensed service from a third-party navigation program. The searchable and navigable listings map may include a search box, filters, and information pop-ups. The pop-ups may provide information corresponding to a listing such as location, address, listing price, listing status, and other details.

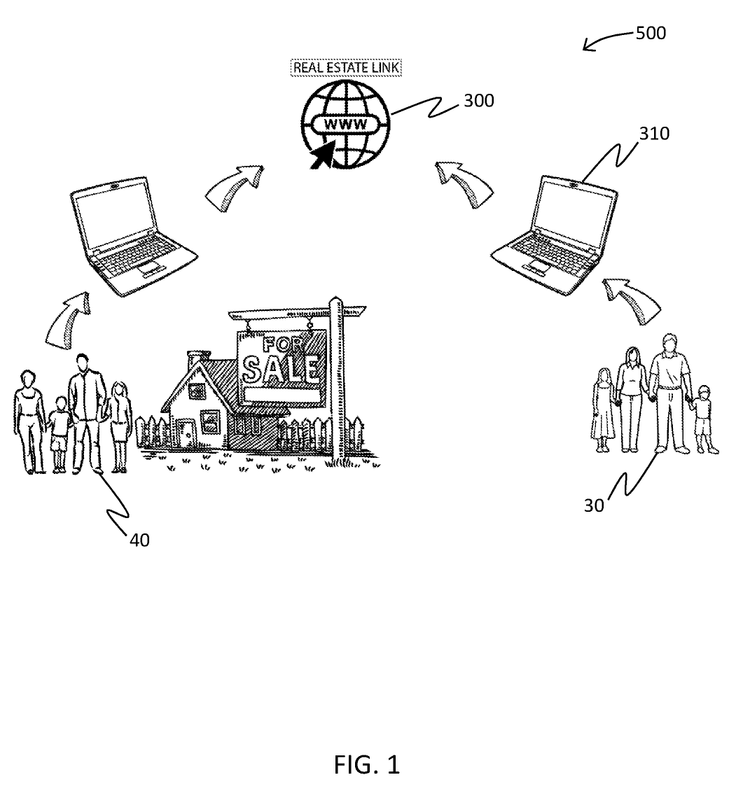

Referring now more specifically to the drawings by numerals of reference, there is shown in FIGS. 1-4, various views of a method 100.

FIG. 1 is a flow chart of a method 500 implementing the method 500 useful for pairing at least one buyer 30 to at least one seller 40 in order to conduct a real estate transaction. The buyers 30 and sellers 40 may be connected via a network 300. Bother buyers 30 and sellers 40 may connect to network 300 via computing devices 310.

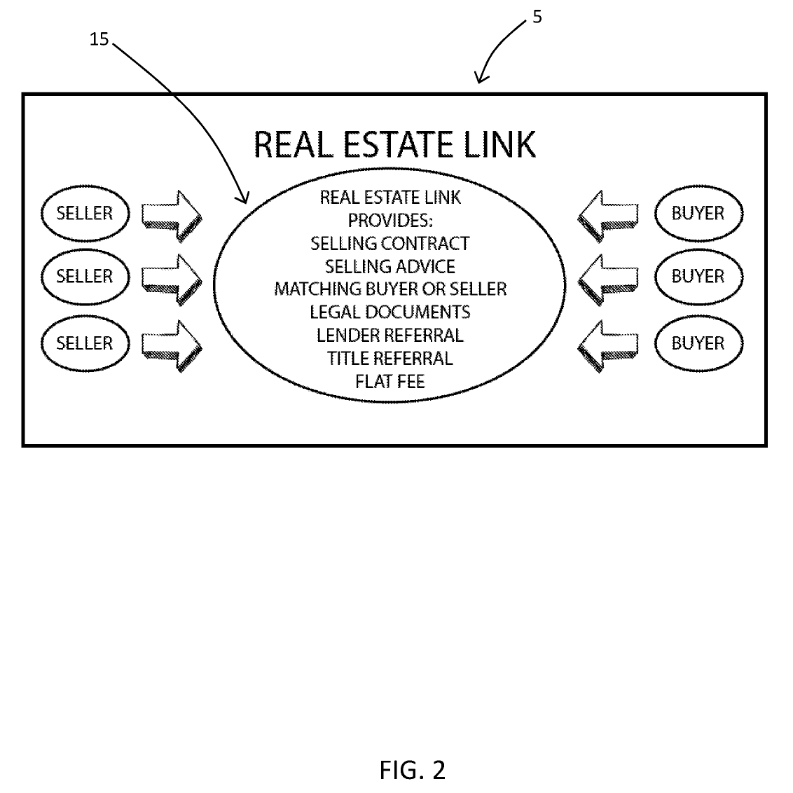

FIG. 2 is a flow chart of the method 500 of FIG. 1, according to an embodiment of the present disclosure. As shown, method 500 (FIG. 1) may be implemented via a website 5. In some embodiments, website 5 may be used with a trade name, such as ‘Real Estate Link’. Website 5 may pair at least one buyer to at least one seller in order to conduct a real estate transaction and associated functions and services 15. Services 15 as conducted by method 500 (FIG. 1) via website 5 may include as illustrated: selling contracts; selling advice; buyer and seller matching; legal documents; lender referrals; title referrals; and flat fee charges.

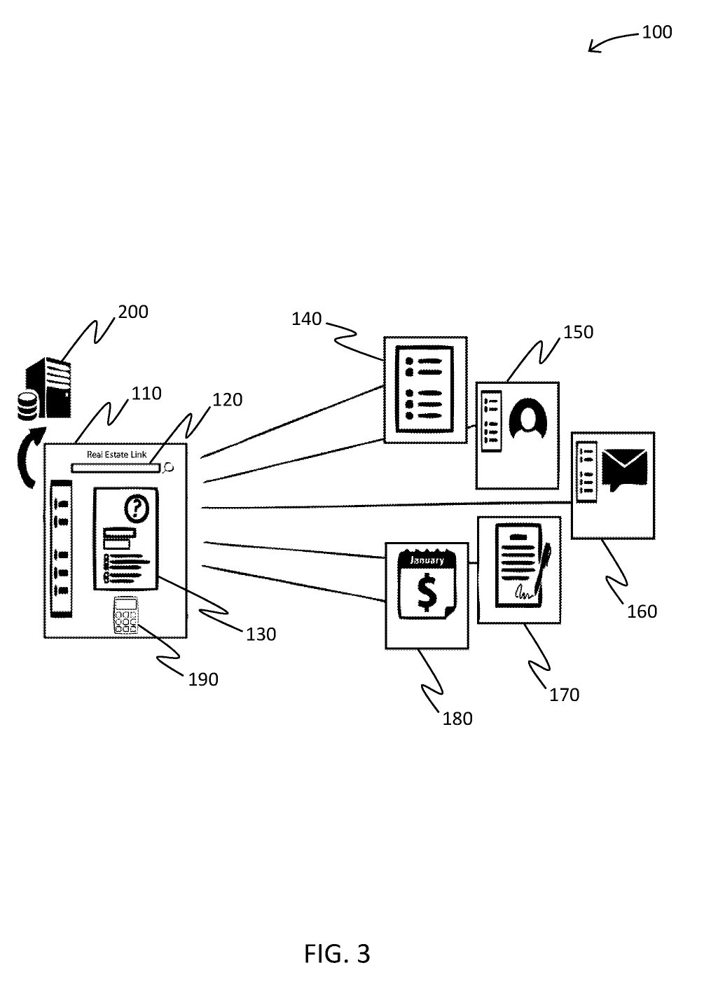

FIG. 3 is an illustration of a user-interface 100 implementing method 500 of FIG. 1, according to an embodiment of the present disclosure. The user-interface 100 may include a homepage 110 associated with website 5 (FIG. 2) and hosted by a server 200 which is able to be displayed on a screen of the computing device 310 (FIG. 1). The homepage 110 may itself include at least one search bar 120 able to receive the real estate search query from the buyer in order to access and provide results from the electronic database; at least one fillable questionnaire 130 for receiving the buyer information; at least one search report page 140 providing the buyer with the at least one match as a response to the buyer's real estate search query; at least one user profile page 150; at least one private message interface 160 permitting the users to communicate with each other; at least one fillable transaction contract 170; and at least one subscription payment page 180. The homepage 110 may further comprising a mortgage calculator 190 which is able to output a monthly payment value in response to at least one user input values, the user input values comprising appraised home values, down payment values, installment values, interest rate, mortgage period, and property tax values. The user-interface 100 is preferably a website.

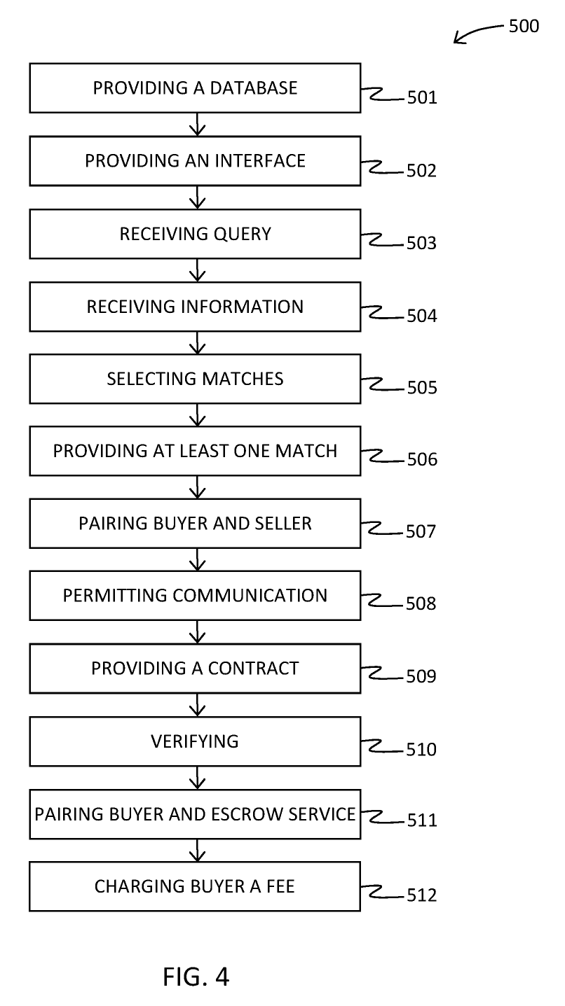

FIG. 4 details method 500 of FIG. 1 for conducting a real estate transaction between users. Method 500 may include step one 501, providing an electronic database, such that the electronic database is able to store a plurality of real estate listings; step two 502, providing a graphical user interface via a computing device enabling a buyer to browse at least one of the plurality of real estate listings; step three 503, receiving a real estate search query from the buyer; step four 504, receiving buyer information, such that the buyer information relates to the buyer's real estate preferences; step five 505, selecting matches from among the plurality real estate listings, such that the matches are selected to match the buyer information as closely as possible given available results; step six 506, providing the buyer with at least one match as a response to the buyer's real estate search query; step seven 507, pairing the buyer to at least one seller, with each seller corresponding to each of the matches; step eight 508, permitting the buyer to communicate and transact directly with the at least one seller; step nine 509, providing a transaction contract to the buyer and the seller; step ten 510, verifying and recording the transaction contract; step eleven 511, pairing the buyer to at least one escrow service; and step twelve 512, charging the buyer a subscription fee.

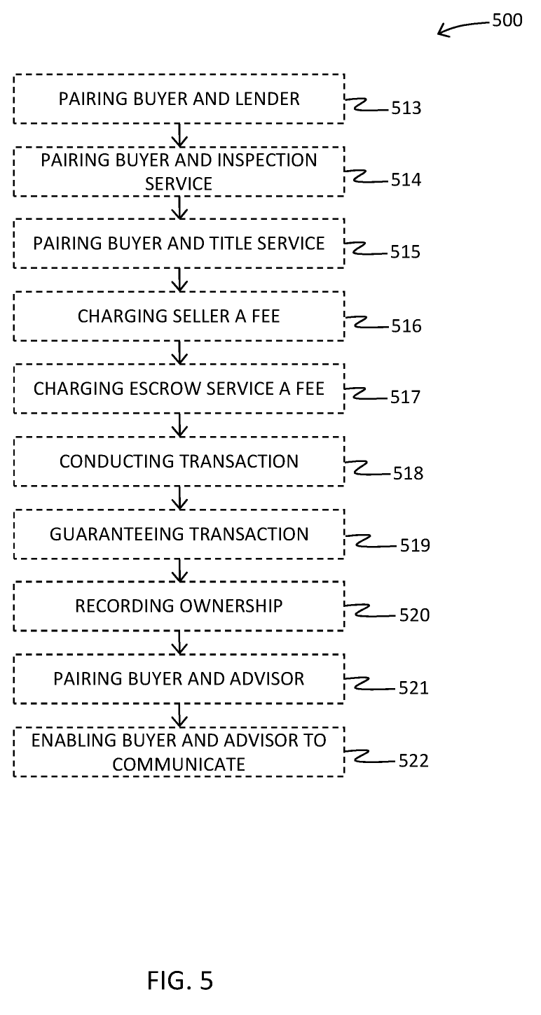

FIG. 5 further details method 500 of FIG. 4, according to an embodiment of the present disclosure. In various embodiments, the following additional steps may be implemented in conjunction with the steps detailed in FIG. 4. The following steps may be added to the steps of FIG. 4 individually or in any suitable reasonable collective combination. The additional steps may include step thirteen 513, further comprising the step of pairing the buyer with at least one lender; step fourteen 514, further comprising the step of pairing the buyer with at least one home inspection service; step fifteen 515, further comprising the step of pairing the buyer with at least one title service; step sixteen 516, further comprising the step of charging the seller the subscription fee; step seventeen 517, further comprising the step of charging the at least one escrow service the subscription fee; step eighteen 518, further comprising the step of conduction a financial transaction between the buyer and the seller; step nineteen 519, further comprising the step of guaranteeing the financial transaction between the buyer and the seller; and step twenty 520, further comprising the step of recording a change in ownership of the at least one real estate listing. Optionally, the subscription fee may be a one-time fee, such that the one-time fee is charged when registering the user's account. Alternatively, the subscription fee may be a recurring fee charged in correlation to a specified period of time. In yet further embodiments, both a subscription fee and a one-time fee may be charged. Method 500 may further comprise step twenty-one 521, pairing the buyer with at least one real estate advisor; and step twenty-two 522, enabling the buyer and the at least one real estate advisor to communicate via personal messages.

It should be noted that steps 513-522 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for pairing buyers and sellers to conduct a real estate transaction, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method for conducting a real estate transaction between users, the method comprising:
providing an electronic database, said electronic database being able to store a plurality of real estate listings;
providing a graphical user interface via a computing device enabling a buyer to browse at least one of the plurality of real estate listings;
receiving a real estate search query from the buyer;
receiving buyer information, said buyer information relating to the real estate preferences of said buyer;
selecting matches from among the plurality of real estate listings, said matches being selected to match the buyer information;
providing the buyer with at least one match as a response to the real estate search query from said buyer;
pairing the buyer to at least one seller, the at least one seller corresponding to each of the matches;
permitting the buyer to communicate and transact directly with the at least one seller;
providing a transaction contract to the buyer and the seller;
verifying and recording the transaction contract;
pairing the buyer to at least one escrow service; and
charging the buyer a subscription fee.

2. The method of claim 1, further comprising the step of pairing the buyer with at least one lender.

3. The method of claim 1, further comprising the step of pairing the buyer with at least one home inspection service.

4. The method of claim 1, further comprising the step of pairing the buyer with at least one title service.

5. The method of claim 1, further comprising the step of charging the seller the subscription fee.

6. The method of claim 1, further comprising the step of charging the at least one escrow service the subscription fee.

7. The method of claim 1, further comprising the step of conducting a financial transaction between the buyer and the seller.

8. The method of claim 1, further comprising the step of guaranteeing the financial transaction between the buyer and the seller.

9. The method of claim 1, further comprising the step of recording a change in ownership of the at least one real estate listing.

10. The method of claim 1, wherein the subscription fee comprises a one-time fee, such that the one-time fee is charged when registering the user's account.

11. The method of claim 1, wherein the subscription fee comprises a recurring fee.

12. The method of claim 1, further comprising the steps of pairing the buyer with at least one real estate advisor; and
enabling the buyer and the at least one real estate advisor to communicate via personal messages.

13. A user-interface implementing the method of claim 1, the user-interface comprising:
a homepage hosted by a server, said homepage being able to be displayed on a screen of the computing device, the homepage including:
at least one search bar able to receive the real estate search query from the buyer in order to access and provide results from the electronic database;
at least one fillable questionnaire for receiving the buyer information;
at least one search report page providing the buyer with the at least one match as a response to the buyer's real estate search query;
at least one user profile page;
at least one private message interface permitting the users to communicate with each other;
at least one fillable transaction contract; and
at least one subscription payment page.

14. The user-interface of claim 13, wherein the user-interface is a website.

15. The user-interface of claim 13, further comprising a mortgage calculator, said mortgage calculator outputting a monthly payment value in response to at least one user input values, said user input values comprising appraised home values, down payment values, installment values, interest rate, mortgage period, and property tax values.

16. An administrative-interface implementing the method of claim 1, the administrative-interface comprising:
a homepage hosted by a server, said homepage being able to be displayed on a screen of the computing device, the homepage including:
at least one search bar able to receive the real estate search query from the buyer in order to access and provide results from the electronic database;
at least one fillable questionnaire for receiving the buyer information;
at least one search report page providing the buyer with the at least one match as a response to the real estate search query of said buyer;
at least one user profile page;
at least one private message interface permitting the users to communicate with each other;
at least one fillable transaction contract;
at least one subscription payment page;
at least one analytics page, said analytics page being configured to display website information including at least registered user information, page visitation statistics, and subscription fee statistics; and
at least one content management tool able to be used by at least one administrator to modify website content.
